(19) United States
(12) Patent Application Publication
(10) Pub. No.: US 2019/0368204 A1
(43) Pub. Date: Dec. 5, 2019

(54) COMPOSITE BOARD AND THE METHOD FOR PRODUCING IT

(71) Applicant: Angle World LLC, Philadelphia, PA (US)

(72) Inventors: Biao Wang, Changzhou (CN); Wenyue Hu, Changzhou (CN); Jae-song Pyon, Philadelphia, PA (US); Cheng Hang, Changzhou (CN)

(21) Appl. No.: 16/307,306

(22) PCT Filed: Apr. 13, 2018
(86) PCT No.: PCT/CN2018/083119

§ 371 Date: Dec. 5, 2018

(51) Int. Cl. E04F 15/10; B32B 3/06; B32B 21/02; E04F 15/02; B32B 19/04; B32B 7/12

(52) U.S. Cl. CPC E04F 15/107; B32B 3/06; B32B 21/02; B32B 2419/04; B32B 19/04; B32B 7/12; E04F 15/02038

(57) ABSTRACT

The present invention provides a composite board and the method for producing it, wherein the composite board includes a base material layer constituting the core part of the composite board; and a wear layer covering and fixed on the base material layer which includes fixings on its both sides, and when at least two composite boards are connected together, the fixings can be coupled with each other to relatively fix the composite boards. The aforementioned method and techniques can enable composite boards to be as rigid and wear-resistant as a tile and moreover, can reduce the time and labor costs required for the installation of the tiles by applying the base material layer in the installation of composite boards.

### TECHNICAL FIELD

The present invention relates to the field of building materials, and in particular to a composite board and the method for producing it.

### BACKGROUND ART

In the field of building materials, the boards used on floors or walls are usually required to be water and moisture resistant, low-cost and not easily deformed. For this reason, laminated floor boards made of fibers or particles, and rigid products such as tiles and stone materials are popular in the market. Depending on different needs, users may use wood, plastic or hard materials on their floors or wall surfaces.

Rigid materials such as tiles and stone materials have a low deformation-bearing capacity, though they are good for decoration, easy to be cleaned and free from corrosion by dirt. Tiles and stone materials may be cracked or broken under stress, so binding agents and cement are often used to manually install tiles and stone materials on walls or floors. Besides, no structure for inter-fixation is additionally provided on a tile or a stone material during or after the cutting process

Even if we use common materials, which are more tenacious but accordingly less rigid, to replace tiles and stone materials, we still face other problems such as a lower rigidity and a higher vulnerability to scratches.

Thus we need a new type of composite board which is as rigid and wear resistant as a title and moreover, which have a board core that can serve as a composite board and reduce the time and labor costs required for the installation of the tiles while maintaining the water and heat resistance of the title and the base material.

### SUMMARY OF THE INVENTION

To overcome the aforementioned technical deficiencies, the present invention provides a composite board and the method for producing it, by which a green installation process can be realized by reducing the use of binding agent and thus the harmful substances produced by the agent during the tile installation process, and by enhancing the use efficiency of the individual parts of the materials. This will bring a promising future to product lines of the home decoration industry.

The present invention discloses a composite board, which includes

a base material layer constituting the core part of the composite board;

a wear layer covering and fixed on the base material layer, which

includes fixings on its both sides, and when at least two composite boards are connected together, the fixings will be coupled with each other to relatively fix the composite boards.

Optimally, the base material layer includes a composite material made of stone powder and plastic;

The wear layer includes rigid materials.

Optimally, the composite material is WPC wood-plastic flooring or SPC stone-plastic flooring;

The rigid materials are tiles or stone materials.

Optimally, the base material layer and the wear layer are molded by a high temperature or cold pressing after they are glued together.

Optimally, the composite board further includes the first binding layer between the base material layer and the wear layer.

Optimally, the composite board further includes a substrate layer, which is fixed on the other side of the base material layer opposite to the wear layer.

Optimally, the composite board further includes the second binding layer between the base material layer and the substrate layer.

Optimally, the fixing is a lock-catch type;

The lock-catch fixing includes a mounting groove and a mounting tongue for realizing the coupling and fixation of the said multiple base material layers.

Optimally, the mounting tongue includes a stopper groove, and the mounting groove on its surface has a stopper tongue;

The stopper tongue couples with the stopper groove, so as to limit the axial and radial movements between the said multiple base material layers.

Optimally, the base material layer includes a mounting surface oriented toward the wear layer;

The wear layer has a pair of edges fit with the ones of the mounting surface, and another pair of edges set within the projection area of the mounting surface.

Optimally, the wear layer on its surface has decorative joints;

The decorative joints are parallel with the direction along the width of the wear layer.

The present invention also discloses a method for producing the composite boards, which includes the following steps:

Step S100: take a base material layer as the core part of the composite board;

Step S200: set fixings on both sides of the base material layer, which are used to relatively fix the composite boards.

Step S300: set and fix a wear layer on the base material layer.

Compared with existing technologies, the aforementioned method and techniques have the following advantages:

1. Solve the installation problems where rigid materials such as tiles and stone materials are used as building materials, which greatly saves labor and time costs;

2. Reduce the use of binding agent and thus the harmful substances produced by the agent during the tile installation process, being consistent with the trend of green decoration;

3. Provide a nearly perfect composite board that takes advantage of both the rigidity of the wear layer and the tenacity of the base material layer and thus can be used in all situations;

4. Under a situation with abnormal changes in temperature, the resistance of the base material layer to water, moisture and deformation can prevent excessive deformation and impacts on the structure of the composite board involved in the present invention.

### DESCRIPTION OF ATTACHED FIGURES

FIG. 1 is the structure of an exemplary composite board according to the invention;

FIG. 2 is the structure comprising the first binding layer of an exemplary composite board according to the invention;

FIG. 3 is the structure comprising the second binding layer of an exemplary composite board according to the invention;

FIG. 4 is the structure comprising both the first and second binding layers of an exemplary composite board according to the invention;

FIG. 5 is the structure of the lock-catch fixing on the base material layer of an exemplary composite board according to the invention;

FIG. 6 is the structure of the lock-catch fixing on the base material layer of another exemplary composite board according to the invention;

FIG. 7 is the structure of the lock-catch fixing on the base material layer of another exemplary composite board according to the invention;

FIG. 8 is the structure of the lock-catch fixing on the base material layer of another exemplary composite board according to the invention;

FIG. 9 is the structure of the lock-catch fixing on the base material layer of another exemplary composite board according to the invention;

FIG. 10 is the structure of the lock-catch fixing on the base material layer of another exemplary composite board according to the invention;

FIG. 11 is the structure of an exemplary composite board with decorative joints according to the invention;

FIG. 12 is the structure of another exemplary composite board with decorative joints according to the invention;

### REFERENCE

100—Composite Board;

110—Base Material Layer, 111—Lock-catch Fixing, 112—Mounting Groove, 113—Mounting Tongue, 114—Stopper Groove, 115—Stopper Tongue;

120—Wear Layer, 121—Decorative Joints;

130—Substrate Layer;

140—First Binding Layer;

150—Second Binding Layer.

### SPECIFIC EMBODIMENTS

In the following sections, the advantages of the present invention will be expounded through figures and specific embodiments.

Typical embodiments will be described in detail in this article, with examples shown in these attached figures. Unless otherwise specified, the same numbers shown in different figures involved in the following description shall mean the same or similar elements. The embodiments described in this article do not represent all of embodiments consistent with what has been disclosed in this article. On the contrary, they are only some examples in conformity with the information disclosed herein as well as the devices and methods that have been explained in detail in the attached Patent Claims.

The terms used in this disclosure are only to describe specific embodiments rather than limit this disclosure. The singular “a type of”, “the said” and “it” used in this disclosure and the attached Patent Claims shall also include their plural forms, unless their other meanings are otherwise specified in context. It shall also be understood that the terms “and/or” used in this article refer to and include any or all possible combinations of one or more associated and listed items.

It shall be understood that although the terms “first, second, third, etc.” may be used in this disclosure to describe information, the information described shall not be limited by these terms. These terms are used only to categorize the information of the same type. For example, without exceeding the range of this disclosure, the “first information” might as well be called as the “second information”. Similarly, the “second information” might be called as the “first information. The term “if” may be interpreted as “when” or “where” or “in response to a certain case”, which depends on the context.

It shall be understood in the description of the present invention that the directions or locations indicated by terms such as “longitudinal”, “transversal”, “up”, “down”, “front”, “back”, “left”, “right”, “vertical”, “horizontal”, “top”, “bottom”, “inside” and “outside”, are only based on the directions or locations shown in the attached figures. These terms are only used to facilitate and simplify the description of the present invention rather than refer to or imply that the stated device or unit must be in a specific direction or at a specific location to be built or operate, and thus shall not be interpreted as a limit on the present invention.

It is needed to be explained that in the description of the present invention, unless otherwise specified and limited, the terms “installation”, “link” and “connection” shall be interpreted expansively. For example, “connection” may refer to a mechanical connection, an electric connection, an internal connection between two units, a direct connection or an indirect connection via a medium. An ordinary technician of this field may interpret the said terms according to the actual situation.

In the following description, the postpositional terms that are used to indicate an element, such as “ module”, “component” or “unit”, are only to facilitate the description of the present invention and have no specific meaning. Therefore, “module” and “component” may be used together.

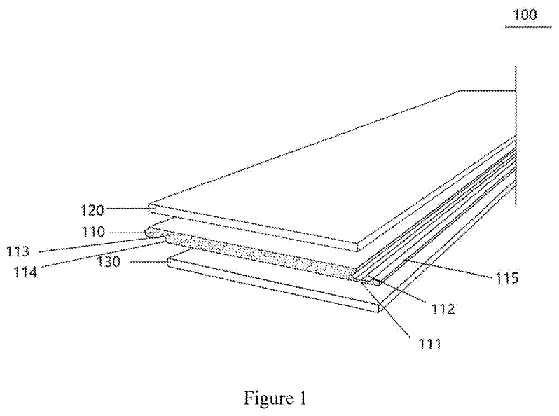

See FIG. 1, which is the structure of the composite board 100 from an optimal embodiment of the present invention. The composite board 100 includes two primary layers: the base material layer 110 and the wear layer 120. The base material layer 110, as the core part of the composite board 100, may be set in the middle of the composite board 100 or serve as a bottom layer to fit together with the composite board 100 and the ground surface or wall surface. The wear layer 120 is fixed on the base material layer 110 by a binding agent or in other ways without need of binding agent. This requires that the composite board 100 of the present invention consists of at least the base material layer 110 and the wear layer 120. More specifically, the wear layer 120 is oriented toward the ground surface or wall surface on which the composite board is to be installed, and will bear the friction with furniture and users. The surface of the wear layer 120 may optionally coated with antiskid, wear resistant and/or matte films, which can enhance its wear resistance and/or appearance.

In an optimal embodiment, the base material layer 110 includes a composite material made of stone powder and plastic; or is an ordinary wooden floor board or a pressed material containing particles of bamboo and/or wood or soft chips of wood or a mixture; or is made of high-density polyethylene materials without chip-like materials, or of original or recycled PVC or the mixture of the both. Regardless of which ingredient described above is used, the composite material is shaped and made into a composite board 100. Similarly, the wear layer 120 includes rigid materials or consists of mainly rigid materials and other ingredients.

More specifically, the composite material included in the material base layer is WPC wood-plastic flooring or SPC stone-plastic flooring. SPC stone-plastic flooring mainly consists of polyvinyl chloride, calcium carbonate, stabilizing agent, ADC foaming agent, NC foaming agent and one or more of other chemical additives such as lubricant, antibacterial agent, stabilizing agent, color matching agent, anti-UV agent and binding agent. The method for producing SPC stone-plastic flooring: use an extruding machine and T-shape moulds to squeeze out the PVC base material; use a three- or four-roll flattener to finish the mixing of PVC wear layer, PVC color film and PVC base material, as well as embossing and shaping by heat in just one process. This process is simple that the combination is realized only by heat without using any glue. More specifically, the production process includes the following steps:

1. Mixing Materials

Place the materials in a prescribed ratio into the high-speed mixing machine to mix well the materials by heat (the hot-rolling temperature may be 125° C.) and eliminate the moisture contained in the materials; after the hot-rolling process, the materials proceed to the cold-rolling process (the cold-rolling temperature may be 55° C.), which is to bring down the temperature of the materials and prevent agglomeration and discoloration; cool down the well-mixed materials in the end.

2. Extruding

Materials are put into the double-screw extruder to be heated and squeezed out to the sheet-making mould head to be processed into sheets. Then the sheets are treated by the four-roll flattener to get a specific thickness. Multiple steps then are taken to finish color coating and wear layer 120 binding (this may be omitted in this invention) on the base material layer. Then the processed ones are cut and shaped.

3. UV Tempering

The shaped products proceed to undergo surface UV treatment and tempering (the hot water temperature to be used ranges from 80 to 120° C. and the cold water temperature is about 10° C.).

4. Slitting, Slotting and Packaging

Finally the materials are slit, slotted, trimmed, chamfered and inspected. Then the products that have passed the inspection are packaged and transferred out.

The materials used to produce SPC stone-plastic flooring are environmentally friendly and free from formaldehyde and other harmful substances such as heavy metals, phthalic acid ester and methyl alcohol. With a thickness ranging from only 4 to 5.5 mm, SPC stone-plastic flooring has a structure resistant to water, fire and wet, and it is free from toxin and odor. Moreover, SPC stone-plastic flooring is better than laminate flooring in terms of scratch resistance, resource use efficiency and anti-skid performance. In addition to the aforementioned properties, SPC stone-plastic flooring also has a contractibility rate ≤1‰ (after tempering) or ≤2.5‰ (before tempering), a density ranging from 1.9 to 2 tons per cubic meter, and thus stable and reliable physical and chemical parameters meeting international and national standards.

WPC (abbreviation of Wood Plastic Composition) wood-plastic flooring is a product made by mixing well wooden raw materials (taking wood cellulose and plant cellulose as the base materials), thermoplastic high polymer materials (plastic) and processing aids and shaped by a heat-based molding and extruding machine. Thus WPC flooring integrates the properties and features of both wooden and plastic materials. In addition to the aforementioned ingredients, WPC flooring also involves one or more of foam regulator (methyl methacrylate-butyl acrylate-styrene polymer), calcium-zinc stabilizer (zinc stearate and calcium stearate), internal lubricant 60, PE wax (Fischer-Tropsch wax), ADC foaming agent, NC foaming agent, and high-temperature lubricant (oxidized polyethlene wax). With the same properties as woods, WPC flooring can be use conveniently like an ordinary wooden material, such as being cut by saw, drilled or nailed. And WPC flooring has both a wood-like texture and a plastic-like resistance to water and corrosion, making it an excellent out-door building material with high durability.

Besides, WPC flooring also has the following properties:

1. Physical properties: high strength and rigidity, anti-skid performance, wear resistance, insect damage immunity, low water absorbability, electrical insulation, as well as resistance to aging, corrosion, static electricity, ultraviolet, heat and fire (can withstand a temperature ranging from −40° C. to 75° C.).

2. Environmental-friendly performance: it is made from ecologically and environmentally friendly woods which are reproducible, and is free from toxins, dangerous chemical components, anti-corrosion agents, formaldehyde and benzene, causing no damage to the atmosphere or the environment. And it is 100% recyclable, reusable by processing technologies, and biodegradable.

3. Appearance and texture: it has a wood-like appearance and texture, and a dimensional stability better than woods; and will not produce cracks, twists or deformation. The product can be made in multiple colors and can maintain its surface color for a long period without needing of second-time painting.

4. Capability of being processed: it has the same properties as woods with which it can be secondarily processed—for example, it can be cut with a saw, planed or glued, or fixed by nails or screws. Meeting the specifications and standards for shaped materials, it is easy to use during construction and installation—it can be processed into a variety of facilities and products through common methods.

Except for the aforementioned WPC wood-plastic flooring and SPC stone-plastic flooring, it shall be understood that the base material layer 110 may also be made of a wooden base board containing or not containing wood powder, a PVC wood-plastic flooring and/or PVC stone-plastic flooring. As the base material layer 110 needs resistance to water, wet, high and low temperatures, WPC wood-plastic flooring and SPC stone-plastic flooring are the better choices for it.

Correspondingly, the rigid materials may be tiles or stone materials. The components of a tile mainly are three mineral materials: clay, quartz and feldspar and some chemical materials. Clay (kaolin) is a plastic substance mainly made of Al₂O₃, which produce plasticity and viscosity during the production process and maintains the resistance to bending loads after the drying process and other functional performances after the baking process. Quartz (silica sand), mainly made of SiO₂, is a solidifying substance used to reduce adhesiveness. During the baking process, some quartz is dissolved in feldspar glass to enhance liquid viscosity and prevent high-temperature deformation. After the porcelain is cooled down, quartz plays a support role (like a skeleton to support a man). Feldspar (stone powder), mainly made of K2O, Na2O, CaO and MgO, is a flux material which can fuse part of quartz and the substances decomposed from Kaolin. The fused high-viscosity glass can glue materials at a high temperature. Glaze is a colored or colorless vitreous substance fused on to the surface of pottery. Glaze slip is made of ground mineral materials (feldspar, quartz, talc and kaolin) and chemical materials in a prescribed ratio (some of the raw materials may be made into frits in advance). Then the glaze slip is applied on a pottery and baked at a particular temperature to become the glaze. Glaze can enhance the mechanical strength, heat stability, dielectric strength and appearance of the product. And a glazed product is easy to clean and free from corrosion by dirt.

Stone materials can be categorized into two types: natural stones and artificial stones. Marble is a kind of natural stone material usually used for flooring, while quartz stone is an artificial one for the same purpose. Marble, namely metamorphosed limestone is mainly made of CaCO₃; quartz is mainly made of SiO₂. Marble is usually used as a building material, while quartz is commonly processed into quartz sand, quartz-based fireproof materials and artificial boards. As a natural stone material, marble has an uneven texture along with cracks or holes, and may involve radiation or harmful substances. All of the stone materials mentioned above have a tight structure, high compressive strength, rigidity, and resistance to wear, wet and temperature-induced deformation, a natural, thick and stately texture, an extremely low swelling coefficient, a long service life and good stability on a flat surface. And they are easy to maintain and free from magnetization and dull appearance.

As the existing rigid materials have the aforementioned properties, in installation we need to apply a binding agent or cement on the bottom surface of the tile or stone material to secure it one by one on the mounting surface according to the design of the flooring or wall, requiring so much time and labor. According to the aforementioned embodiments, the base material layer 110 has a high tenacity and resistance to temperature-induced deformation; the wear layer 120 has a high rigidity, but is easy to crack under stress. After being combined with the wear layer 120, the base material layer 110 serve can facilitate the installation, while the wear layer 120 can further enhance the resistance of the base material layer 110 to pressure and deformation. Furthermore, fixings are built in or additionally installed on both sides of the base material layer 110. If a user wants to combine two or more composite boards 100 together, he/she just needs to match and connect together the fixings of which one is on a side (for example, the left side) of a base material layer 110 of a composite board 100 and the other one is on a side (for example, the right side) of the neighboring base material layer of another composite board 100, and then the two composite boards 100 will be fixed together. And it shall be understood that no binding agent is required for the wear layer 120 during the installation process. All the materials as well as mounting surfaces needed for the installation are provided by the base material layer, which saves great labor and time costs.

When a composite board 100 is being shaped, the base material layer 110 and wear layer 120 can be shaped together by high-temperature pressing or by low-temperature pressing combined with binding agent. This process can be finished in the factory producing the composite board 100 without need of on-site operation by a user. The composite board 100 may be installed on a self-leveling or a leveled ground or wall surface, for example, a cement floor, a terrazzo floor or a floor made of tile, marble and/or wood. And it is required to remove greasy dirt, dust and any residue on the floor or wall surface before installation. The installation of composite boards 100 may begin with consideration of the shape of the base material layer 110 and from the upper left corner of the room in which mounting surfaces are ready. Place the first composite board 100 and make sure that the fixings are outward and exposed. Reserve some space between the ground and wall surfaces in case the composite floor swells naturally. The larger area of installation, the wider reserved space is required. When installing the second composite board 100 in the first row, one should insert the fixing of the second composite board 100 into the fixing of the first composite board 100. Then install the other composite boards 100 in the first row and finish the installation of all composite boards 100 in the same way.

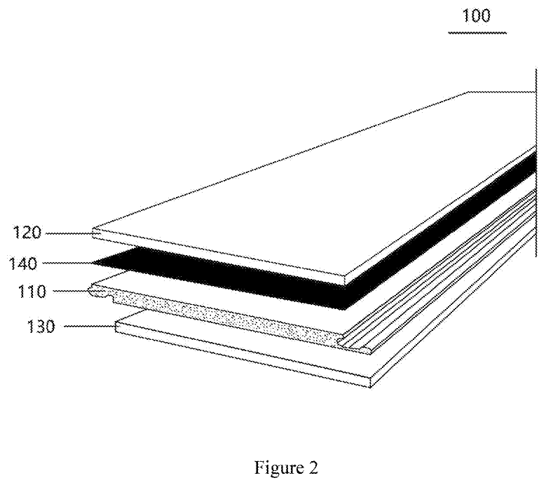

See FIGS. 2 to 4. The figures show the other basic layers contained in the composite boards 100 of different embodiments. FIG. 2 shows that the composite board 100 further includes the first binding layer 140, which is bound between the base material layer 110 and the wear layer 120. The first binding layer 140 may be a PVC layer used to enhance the tenacity of the base material layer 110.

Optimally or optionally, the composite board 100 may further include the substrate layer 130, which is set against the base material layer 110 on one side (the other side of the base material layer 110 is against the wear layer 120), namely, the wear layer 120 and substrate layer 130 are set on both sides of the base material layer 110, respectively. Similarly, the substrate layer 130 is fixed together with the base material layer 110. The optional substrate layer 130 may be made of IXPE plastic layer, EVA or Cork layer in order to reduce noise and increase the flexibility of the composite board 100.

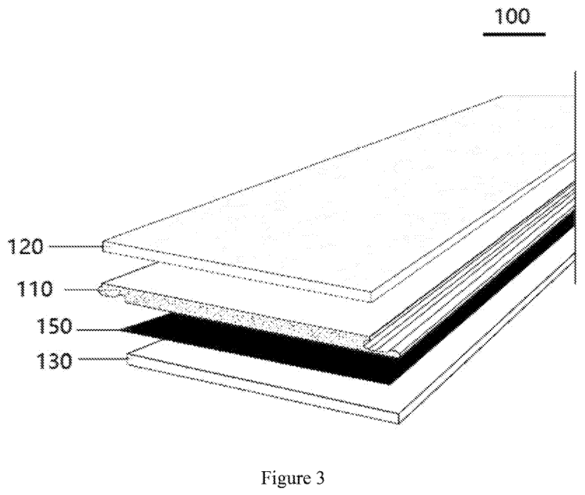

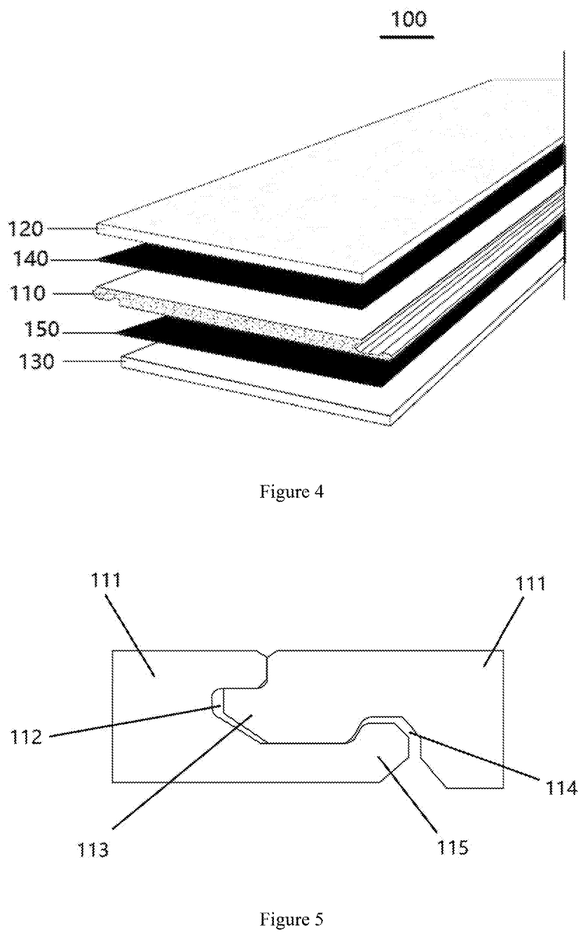

See FIGS. 3 and 4. In these different embodiments of which one includes the first binding layer 140 but the other one does not, the composite board 100 may further include the second binding layer 150, which is bound between the base material layer 110 and the substrate layer 130. If no substrate layer 130 is provided in an embodiment, the composite board may be installed on the surface via the second binding layer 150. The second binding layer 150 may be a PVC layer, which can be installed on the surface by binding agent. And because of the binding strength between the PVC layer and the ground surface, the composite board 100 as a whole will be more firmly fixed.

In another optimal embodiment, lock-catch fixings 111 are set on the base material layer 110. The lock-catch fixings 111 are to be use in pairs and built in the WPC wood-plastic flooring or SPC stone-plastic flooring. Each pair of lock-catch fixings are set on both sides of the base material layer 110. That is to say, the fixings set on both sides of each base material layer 110 are unsymmetrical. Take the mounting groove 112 and mounting tongue 113 as an example: when the mounting tongue 113 of the base material layer 110 is inserted into the mounting groove 112 of the neighboring board, the two fixings will be matched and coupled to fix together the two neighboring base material layers 110.

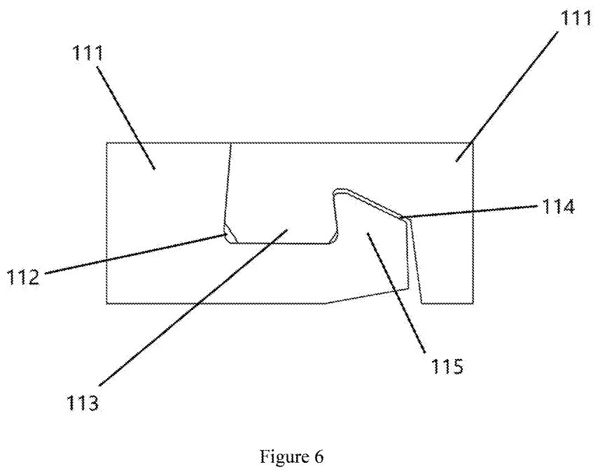

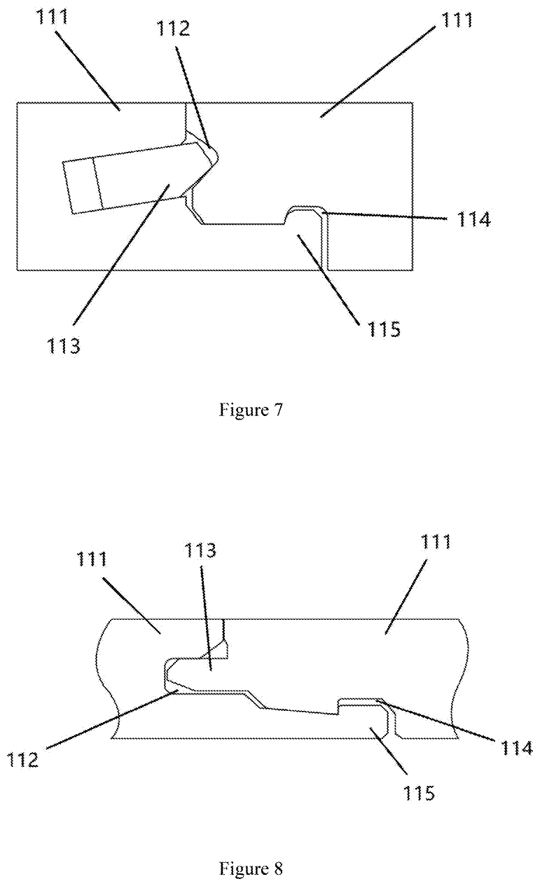

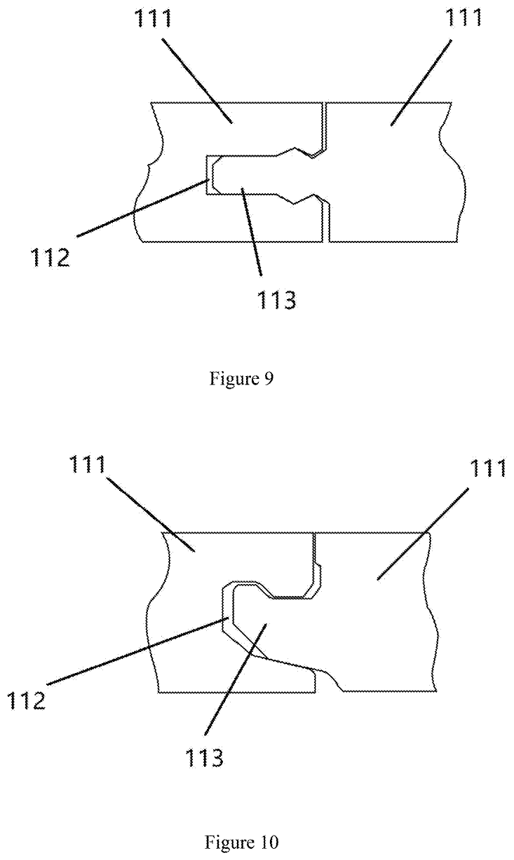

See FIG. 2 to 10. These figures show the structures of lock-catch fixings of different embodiments. According to the embodiments shown in these figures, mounting tongue 113 of lock-catch fixing 111 further includes the stopper groove 114. The stopper tongue 115 is set on surface of the mounting groove 112. In order to couple the mounting groove 112 with the mounting tongue 113, it is required to insert the mounting tongue 113 into the mounting groove 112 transversally rather than along the direction of the opening. This is because the opening of the mounting groove 112 is designed to be smaller than the tip of the mounting tongue 113 (the tongue cannot enter the groove if it goes along the direction of the opening). Furthermore, because of the design of the stopper groove 114 and stopper tongue 115, in a transversal insertion, the stopper tongue 115 will be coupled with and stuck in the stopper groove 114, which further limits the axial and longitudinal movements between the base material layers 110. The cross sections of the mounting groove 112, mounting tongue 113, stopper groove 114 and stopper tongue 115 may be in various irregular shapes, such as a trapezoid or a triangle. It shall be understood that the mounting groove 112 and stopper groove 114 are not fully coupled with the mounting tongue 113 and stopper tongue 115, respectively, as there is some space reserved between them to accommodate heat-induced deformation and to facilitate assembly and disassembly.

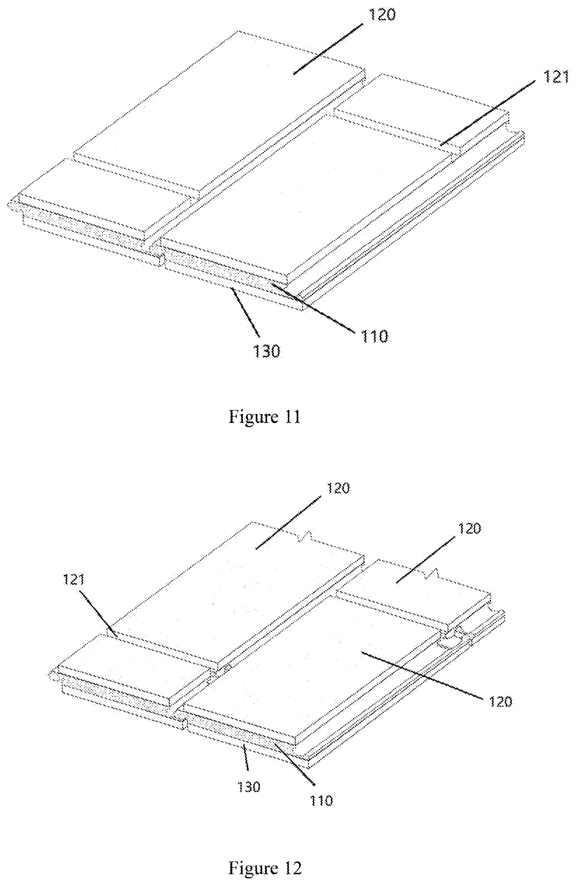

See FIG. 11. Both the base material layer 110 and the wear layer 120 are in the shape of a rectangle. The surface of the base material layer 110 toward the wear layer 120 is a mounting surface. When the wear layer 120 is mounted on the mounting surface of the base material layer 110 to constitute the integral structure of the composite board 100, the size of the wear layer 120 is equal to or smaller than that of the mounting surface of the base material layer 110, which allows the pair of edges of the wear layer 120 to fit with that of the mounting surface, so that when the composite board 100 is installed on a ground or wall surface, one cannot see the edges of the base material layer 110 when his line of sight is vertical to the ground or wall surface. The another pair of edges of the wear layer 120 may be designed to be aligned with the base material layer 110 or more close to the inside so that the edges are within the projection area of the mounting surface—in other words, upon the installation of the neighboring composite boards 110, their base material layers 110 will be against each other tightly while their wear layers 120 will have some space between them, which is reserved for fillers or decorative joints 121 of tiles.

The pair of edges mentioned above refers to a pairs of long or short edges on a base material layer 110 or a wear layer 120. If the base material 110 and/or wear layer 120 is in an irregular shape, then the pair of edges may refer to two neighboring or non-neighboring straight lines or curves.

See FIG. 11 again. The wear layer 120 may consist of multiple sections assembled together or be an integral structure. When multiple sections of a wear layer 120 are glued and assembled on a base material layer 110, some space are reserved between the sections for decorative joints 121; in the case of an integral structure, concave decorative joints 121 are set on the surface of the wear layer 120 and parallel with the width direction of the wear layer 120. With the product mentioned above, a user does not need to do additional work to make decorative joints 121. In other words, the multiple steps required for the tile installation are finished during the production process of the composite boards 100, which saves great labor and time costs.

See FIG. 12. Unlike FIG. 11, the base material layer 110 and wear layer 120 has been divided into multiple sections in advance to form decorative joints. As shown in the figure, a single base material layer 110 is covered by a wear layer 120. In this case, what would the products look like after they are installed has been determined during the production process, by which the installation process is further simplified.

The present invention also provides the method for producing the composite boards, which includes the following steps:

Step S100: Take a base material layer as the core part of the composite board;

Step S200: Set fixings on both sides of the base material layer, which are used to relatively fix the composite boards.

Step S300: Set and fix a wear layer on the base material layer. Upon the installation of the base material layer, the position of the wear layer will be fixed too because the wear layer is fixed together with the material base layer. Therefore, no mounting structure is needed for the wear layer—the job is done by the base material layer.

In the aforementioned production method it shall be understood that according to the most basic requirements of the construction industry, the composite boards should have the same thickness; namely, the thicknesses of the base material layers and the wear layers of the composite boards installed on the same mounting surface should be the same. Furthermore, as the base material layer is used for mounting and fixation, it can replace some of the existing tiles without increasing the thickness of the existing tile floor, namely, without reducing the indoor space or storey height.

It should be noted that although the embodiments of the present invention are optimal, they shall not limit the present invention in any way. Any technician who is familiar with this field might modify or change the technical information disclosed above into the same effective embodiments which however, are not detached from the technical solution of the present invention. Any modification or non-substantive change or modification in the aforementioned embodiments according to the substantial technical solution of the present invention shall be covered by the technical solution of the present invention.

1. A composite board including
a base material layer constituting the core part of the composite board;
a wear layer covering and fixed on the base material layer
which includes fixings on its both sides, and when at least two composite boards are connected together, the fixings will be coupled with each other to relatively fix the composite boards.

2. The composite board of claim 1, wherein
the base material layer includes a composite material made of stone powder and plastic; and
the wear layer includes rigid materials.

3. The composite board of claim 2, wherein
the composite material is WPC wood-plastic flooring or SPC stone-plastic flooring; and
the rigid materials are tiles or stone materials.

4. The composite board of claim 1, wherein
the base material layer and the wear layer are molded by a high temperature or cold pressing after they are glued together.

5. The composite board of claim 1, wherein
the composite board further includes
the first binding layer between the base material layer and the wear layer.

6. The composite board of claim 1, wherein
the composite board further includes
a substrate layer, which is fixed on the other side of the base material layer opposite to the wear layer.

7. The composite board of claim 6, wherein
the composite board further includes
the second binding layer between the base material layer and the substrate layer.

8. The composite board of claim 1, wherein
the fixing is a lock-catch type; and
the lock-catch fixing includes a mounting groove and a mounting tongue for realizing the coupling and fixation of the said multiple base material layers.

9. The composite board of claim 8, wherein
the mounting tongue includes a stopper groove; and the mounting groove on its surface has a stopper tongue;
the stopper tongue couples with the stopper groove, so as to limit the axial and radial movements between the said multiple base material layers.

10. The composite board of claim 1, wherein
the base material layer includes a mounting surface oriented toward the wear layer; and
the wear layer has a pair of edges fit with the ones of the mounting surface, and another pair of edges set within the projection area of the mounting surface.

11. The composite board of claim 1, wherein
the wear layer on its surface has decorative joints which are parallel with the direction along the width of the wear layer.

12. A method for producing the composite boards, which includes the following steps:
Take a base material layer as the core part of the composite board;
Set fixings on both sides of the base material layer, which are used to relatively fix the composite boards; and
Set and fix a wear layer on the base material layer.
